(19) United States
(12) Patent Application Publication
(10) Pub. No.: US 2007/0065000 A1
(43) Pub. Date: Mar. 22, 2007

(54) Apparatus and method for producing character sculpture

(76) Inventor: Joonpyo Hong, Kangnam-gu (KR)

Correspondence Address: CANTOR COLBURN, LLP, 55 GRIFFIN ROAD SOUTH, BLOOMFIELD, CT, 06002, US

(21) Appl. No.: 11/231,695

(22) Filed: Sep. 21, 2005

(51) Int. Cl. G06K 9/00

(52) U.S. Cl. 382/154

(57) ABSTRACT

Disclosed herein is an apparatus and method for producing a character sculpture, wherein, when a user selects a predetermined image among 3-dimensional (3D) images with various garments or body-shapes stored in a database, it is capable of sculpturing a character sculpture corresponding to a mixed image of a user's face, adding an animation function to the mixed image, and outputting the animated image to a mobile phone, etc. The character sculpture producing apparatus includes a keyboard through which a user may input an operation signal; a scanner for scanning a corresponding object and outputting scanned data; a database for storing a 3D image having various body-shapes or garments and an expression image which is capable of being replaced with each part of a body; a control unit for converting the scanned data inputted from the scanner into 3D data, creating a scanned image, mixing the scanned image with the 3D image and expression image which are read from the database, and creating a sculptured image; a display for displaying the scanned image or the sculptured image under control of the control unit; and a 3D sculpturing device for engraving materials under control of the control unit, and producing a character sculpture corresponding to the sculptured image.

### BACKGROUND OF THE INVENTION

1. Field of the Invention

The present invention relates to an apparatus and method for producing a character sculpture, and more particularly to an apparatus and method for producing a character sculpture, wherein, by selecting a predetermined image among 3-dimensional (3D) images with various body-shapes or garments stored in a database, it is capable of producing a character sculpture corresponding to a mixed image of a user's face, and by adding an animation function to the mixed image it is capable of outputting the animated image to a mobile phone, USB storage, and other portable storage media of the user.

2. Description of the Related Art

As well known to those skilled in the art, if a user wishes to produce a personalized character, the user must have directly visited a character provider for producing a character. Conventionally, the character provider manually sketched the user's face or the like to produce the character.

However, this is very cumbersome to the user. In addition, this is a heavy burden to the user considering to time and cost. In addition, if the user wishes to produce various characters, various drawings must be sketched for each corresponding character. The character is generally used to create a new image by depicting a characterizing part of the user into a simplifying shape. However, there is not yet introduced an apparatus which can automatically and simply produce a character.

On the other hand, an automat for capturing a sticker picture has a similar concept with the character producing apparatus. In the sticker-picture capture automat, a user inserts a predetermined amount of money, selects any one of a plurality of background images, manipulates an installed camera, and then captures the user's shape onto the selected background image. However, the sticker-picture capture automat cannot have any function relating to the character production except that the user as a simple object selects the background image and produces the user's own original photo.

### SUMMARY OF THE INVENTION

Therefore, the present invention has been made in view of the above problems, and it is an object of the present invention to provide an apparatus and method for producing a character sculpture, wherein, by scanning a user's face in 2D or 3D, converting the 2-dimensional (2D) scanned data into 3D data, and mixing the converted 3D data with various images having body-shapes, garments and expressions, it is capable of producing a desired character and sculpture a real sculpture corresponding to the produced character with milling and engraving or printing device.

It is another object of the present invention to provide an apparatus and method for producing a character sculpture, wherein, in the case where a predetermined character is produced after mixing scanned data with stored images, it is capable of outputting an animated image to a mobile phone, a USB storage, and other portable storage media of a user by adding an animation function to the produced character.

In accordance with an aspect of the present invention, the above and other objects can be accomplished by the provision of a method for producing a character sculpture, the method comprising the steps of: a) determining whether a signal for activating a scanner is inputted, activating the scanner when the scanner activating signal is inputted, and receiving 3-dimensional(3D) or 2-dimensional (2D) scanned (photo) data; b) converting the 2D scanned data into 3-dimensional (3D) data, and storing the 3D data; c) selecting a 3D image which is 3-dimensionally produced with various sizes and shapes or an expression image for each part of a face which shows various expressions, mixing the scanned image with the selected 3D image and expression image, and creating a sculptured image; and d) determining whether a sculpture allowance signal is inputted, and producing the sculpture corresponding to the sculptured image when the sculpture allowance signal is inputted.

Preferably, the method may further includes the steps of: e) determining whether an animation function selection signal is inputted after the sculpture was produced; f) outputting, when the animation function selection signal is inputted, motion data corresponding to each stored image which expresses each different motion; and g) adding, when a signal for selecting any one of the motion data among the plurality of the motion data is received, the selected motion data to the sculptured image, creating an animated image, and outputting the animated image.

In accordance with another aspect of the present invention, there is provided an apparatus for producing a character sculpture, the apparatus comprising: a keyboard through which a user may input an operation signal; a scanner for scanning a corresponding object and outputting scanned data; a database for storing a 3-dimensional (3D) image having various body-shapes or garments and an expression image which is capable of being replaced with each part of a body; a control unit for converting the scanned data inputted from the scanner into 3D data, creating a scanned image, mixing the scanned image with the 3D image and expression image which are read from the database, and creating a sculptured image; a display for displaying the scanned image or the sculptured image under control of the control unit; and a 3D sculpturing device for printing, milling or engraving materials under control of the control unit, and producing a character sculpture corresponding to the sculptured image.

Preferably, the control unit includes at least any one of: a scanning module for controlling driving of the scanner in 3D or 2D, converting 2-dimentional (2D) scanned data into 3D data, and creating a 3d face scanned image; an image mixing module for mixing the scanned face image with the 3D full body image and expression image, and creating a sculptured image which is characterized and caricatured; and an animation module for animationizing the sculptured image mixed through the image mixing module, and endowing predetermined motions to the sculptured image.

Preferably, the apparatus may further include: an animation outputting unit for outputting the image animated by the animation module in the control unit; a storage for storing the animation data inputted from the animation outputting unit, on a USB storage or a compact disc (CD) which is loaded therein; and a terminal outputting unit for outputting the animation data inputted from the animation outputting unit, to a mobile terminal which is connected thereto.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing an apparatus for producing a character sculpture according to the present invention;

FIG. 2 is a block diagram showing the configuration of an apparatus for producing a character sculpture according to the present invention;

FIG. 3 is a flowchart illustrating a method for producing a character sculpture according to the present invention; and

FIG. 4 is a view illustrating a schematic procedure for producing a sculptured image for a character sculpture according to an embodiment of the present invention.

### DESCRIPTION OF THE PREFERRED EMBODIMENTS

Now, preferred embodiments of the present invention will be described in detail with reference to the annexed drawings.

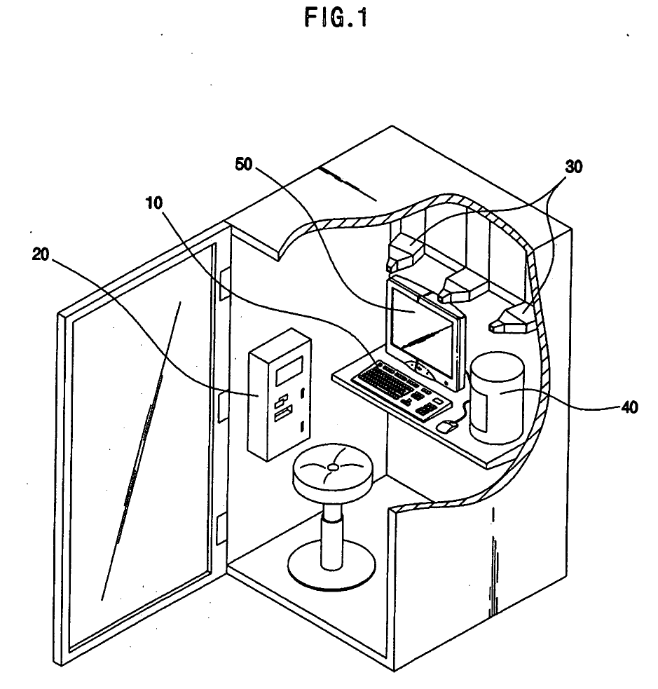

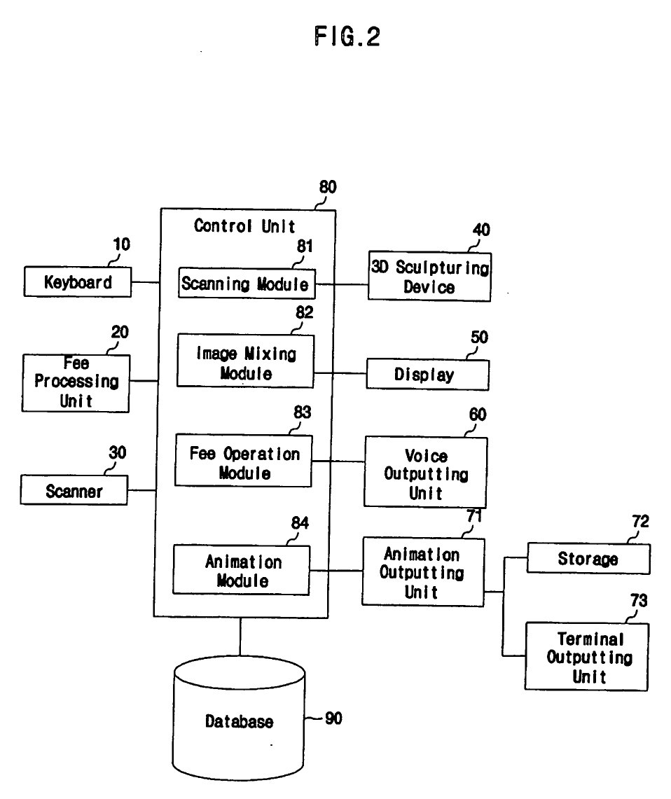

FIG. 1 is a perspective view showing an apparatus for producing a character sculpture according to the present invention. FIG. 2 is a block diagram showing the configuration of an apparatus for producing a character sculpture according to the present invention.

Referring to FIGS. 1 and 2, the character sculpture producing apparatus according to the present invention includes a keyboard 10 through which a user may input an operational signal; a fee processing unit 20 for detecting bills or coins which are inserted thereinto and calculating the remainder of the money; a scanner 30 for scanning a user's face; a control unit 80 for controlling production of a sculpture image; a 3D sculpturing device 40 for printing, milling or engraving a sculpture; a display 50 for displaying each produced image; a voice outputting unit 60 for outputting a voice response; an animation outputting unit 71 for outputting an animation image; a storage 72 for storing the animation image in a storage medium such as a USB storage, a compact disc (CD), etc.; a terminal outputting unit 73 for outputting the animation image to a mobile phone, etc.; and a database 90 for storing various 3D images and expression images and image motion data.

The control unit 80 includes a scanning module 81 for creating a scanned image; an image mixing module 82 for mixing the scanned image with the 3D image and expression image, and creating a sculptured image which is characterized and caricatured; a fee operation module 83 for detecting a fee which is inserted into the fee processing unit 20 and adjusting the fee; and an animation module 84 for endowing predetermined motions to the sculptured image, and animationizing the sculptured image.

Thus, the scanning module 81 in the control unit 80 converts 2-dimentional (2D) scanned data inputted from the scanner 30, if a user selected 2D scanning from 2D and 3D scanning options, into 3D data, and creates a scanned image. Since the animation module 82 reads out the 3D images and expression images stored in the database 90 by a selection of a user, and mixes the sculptured image with the 3D images and expression images, the sculptured image which is characterized and caricatured may be created. In addition, the animation module 84 animationizes the sculptured image, and then the animation outputting unit 71 outputs the animated image to the USB storage, the CD or the mobile phone, etc.

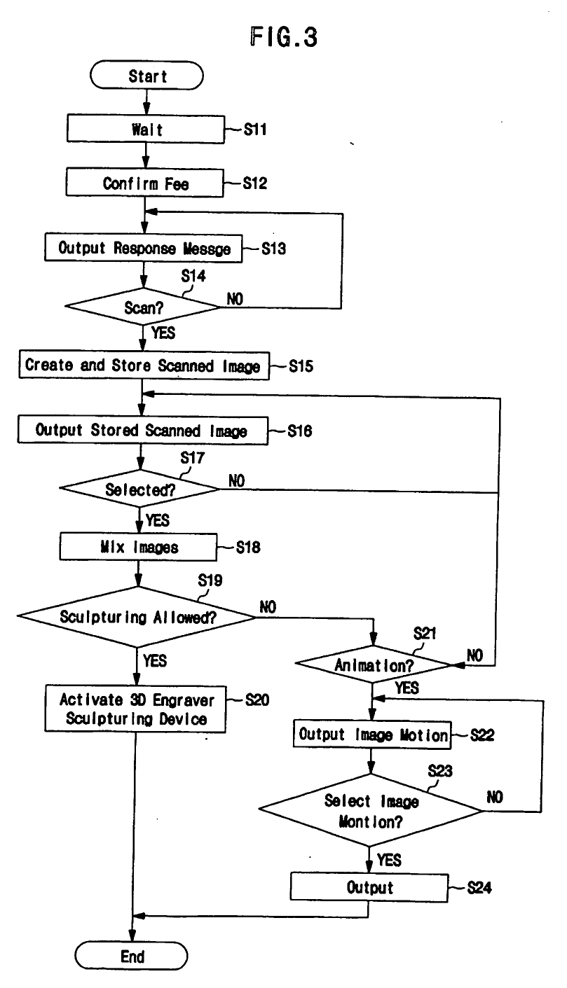

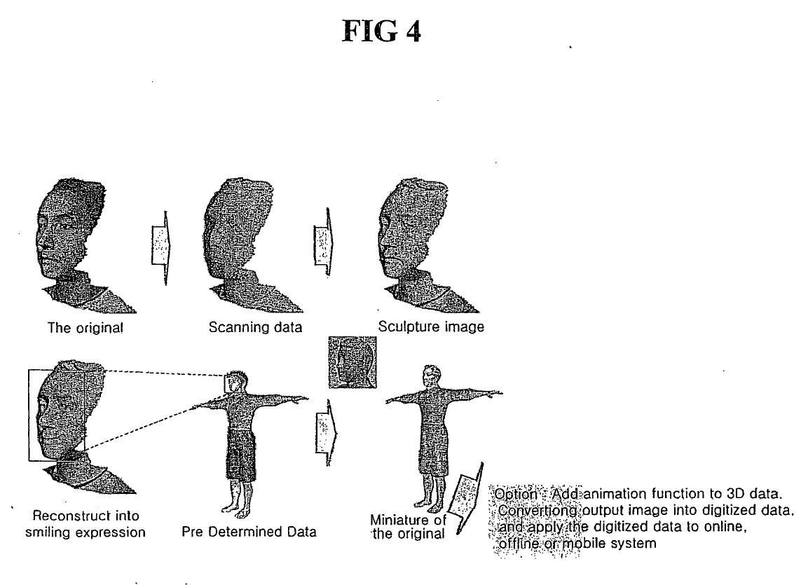

That is, according to the present invention, the 3D images with various body-shapes and garments, the expression images which show various facial expressions, and the image motion data which show various motions are stored. In addition, in the case where the face of the user is scanned and the scanned image is created, the sculptured image is created according to the selection of the user, wherein the sculptured image is characterized and caricatured with various garments and body-shapes, and the expressions. In addition, a sculpture of a character that is selected and made by the user may be produced by sculpturing (milling, printing, and engraving) materials such as ABS, modeling wax, brass, aluminum, other non-ferrous metals, silicone, plastic, liquid plastic, urethane rubber, V-Polymer, etc using the sculptured image. Otherwise, the animated image may be outputted to the USB storage, the mobile phone, and other storage media of the user by animationizing the sculptured image. A character sculpture producing method using the above-mentioned components will be described in detail with reference to the following FIGS. 3 and 4.

FIG. 3 is a flowchart illustrating a method for producing a character sculpture according to the present invention. FIG. 4 is a view illustrating a schematic procedure for producing a sculptured image for a character sculpture according to an embodiment of the present invention.

To begin with, as shown in FIGS. 3 and 4, when a user inserts some coins or bills by the predetermined amount of money into the fee processing unit 20 arranged in the character sculpture producing apparatus according to the present invention, the fee processing unit 20 detects a type of the inserted coins or bills and the number thereof, and outputs the detected result to the control unit 80.

In the first step for waiting (S11), the control unit 80 drives the fee operation module 83. The fee operation module 83 determines the sum of the inserted coins or bills depending on the detected result, and adjusts a predetermined fee and the inserted coins or bills (S12). When the remainder of the money is present, it is repaid through the fee processing unit 20. Otherwise, when the fee operation module 83 determines that the sum of the inserted coins or bills is below the predetermined fee, the voice outputting unit 60 or the display 50 outputs a response message for requesting an additional fee (S13).

In addition, when the fee is inserted in the fee processing unit 20 according to a fee adjustment of the fee operation module 83, the control unit 80 controls the voice outputting unit 60 or the display 50 and displays a voice response or a display screen in order to use the scanner 30 (S13).

Next, the control unit 80 determines whether a scanner driving signal is received (S14). The user takes an arranged seat and inputs the scanner driving signal to the scanning module 81. If the scanning module 81 receives the scanner driving signal, the scanning module 81 drives the scanner 30 to scan the user's face in 2D or 3D according to a user's preference and selection.

The scanner 30 scans the user's face, creates 3D or 2D scanned data, and outputs the 3D scanned data to mixing module 82, or the 2D scanned data to the control unit 80. Thus, the scanning module 81 in the control unit 80 converts the 2D scanned data inputted from the scanner 30 into 3D data, creates scanned image, and temporally stores the scanned image (S15).

Next, the image mixing module 82 reads out 3D images with various body-shapes, garments, and poses stored in the database 90, and displays the 3D images on the display 50 (S16).

Next, the image mixing module 82 in the control unit 80 determines whether an image selection signal for selecting any one of the read 3D images is received (S17).

When the user selects any one of the 3D images which are read through the keyboard 10, the image mixing module 82 mixes the scanned image with the selected 3D image, and outputs the mixed image to the display 50.

In addition, the image mixing module 82 reads out expression images stored in the database 90, and outputs the expression images to the display 50. When the user selects any one of the expression images which are read through the keyboard 10, a corresponding signal is applied to the control unit 80.

The image mixing module 82 additionally mixes the expression images with the image which mixed the scanned data with the 3D images, that is, additionally mixes the image having predetermined body-shapes and garments with the expression image such as smiling expression, crying expression, etc. In addition, the image mixing module 82 creates a sculptured image which is characterized and caricatured, and outputs the sculptured image to the display 50 (S18).

Next, the control unit 80 determines whether a sculpturing allowance signal is inputted (S19).

When the sculpturing allowance signal is inputted, the control unit 80 drives the 3D sculpturing device 40 to produce a character sculpture corresponding to the sculptured image. Herein, the 3D sculpturing device 40 mill or engrave hard materials such as ABS, modeling wax, brass, aluminum, other non-ferrous metals, silicone, and plastic, or print with liquid solutions such as silicone, liquid plastic, plaster, urethane rubber, V-Polymer, etc, for example, a rectangular cubic type of ABS, mills or engraves the materials from the outside to the inside, or printing with liquid solution's accumulation finally produces the sculpture corresponding to the sculptured image (S20) with different texture.

The control unit 80 detects a driving state of the 3D sculpturing device 40, controls the voice outputting unit 60 and the display 50 when the production of the sculpture is completed, and outputs a completion message to the voice outputting unit 60 and the display 50. Thus, the user may remove the completed sculpture.

Otherwise, when the sculpture allowance signal is not inputted in the step (S19) of the sculpture allowance determination, the control unit 80 determines whether an animation function selection signal is inputted from the keyboard 10 (S21).

Next, when the animation function selection signal is inputted, the control unit 80 drives the animation module 84. The animation module 84 reads out a list of image motions which shows various motions stored in the database 90, and outputs the list of image motions to the display 50 (S22).

Next, the animation module 84 determines whether an image motion selection signal is inputted from the keyboard 10. If the motion selection signal is inputted, the animation module 84 adds the selected motion data to the sculpture image, and applies the animation function to the sculpture image to have a predetermined motion (S23).

According to methods for outputting the animated sculpture image, the animation module 84 may output a voice message for guiding to select a storage medium such as the USB storage, the CD, etc. or a mobile terminal through the voice outputting unit 60, or may output a text message by controlling the display 50.

When the user selects the storage medium or the mobile terminal such as a mobile phone, a PDA, a notebook computer or the like through the keyboard 10, the animation module 84 controls the animation outputting module 71. Thus, the animation outputting module 71 stores the corresponding data in the USB storage or the CD through the storage medium 72 under control of the control unit 80, otherwise the animation outputting module 71 outputs data to the mobile terminal connected to the terminal outputting unit 73.

Therefore, the user can produce a personalized character sculpture and also install the animated character image to the mobile phone, etc.

As apparent from the above description, the present invention provides an apparatus and method for producing a character sculpture, wherein, by storing 3D images with various body-shapes or garments and facial expression images, and mixing scanned data of the user with the 3D images and expression images, the user can desirably create character images or caricature images, thereby giving the very high user satisfaction. In addition, since the user can create the personalized by simple keyboard operations, the user can easily use the character.

In addition, the present invention provides an apparatus and method for producing a character sculpture, wherein, by adding an animation function to a character created through the scan image, 3D images and expression images, outputting and storing the animated image to a mobile terminal, a storage medium or the like, thereby the user can easily apply the animated image to a background screen of the user's own mobile phone or a notebook computer, an e-mail or the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for producing a character sculpture, the method comprising the steps of:
a) determining whether a signal for activating a scanner is inputted, activating the scanner when the scanner activating signal is inputted, and receiving 3-dimensional (3D) or 2-dimensional (2D) scanned data;
b) storing the 3D data, and converting the 2D scanned data into 3-dimensional (3D) data, and storing the 3D data;
c) selecting a 3D image which is 3-dimensionally produced with various sizes and shapes or an expression image which shows various facial expressions, mixing the scanned image with the selected 3D image and expression image, and creating a sculptured image; and
d) determining whether a sculpture allowance signal is inputted, and producing the sculpture corresponding to the sculptured image when the sculpture allowance signal is inputted.

2. The method as set forth in claim 1, further comprising the steps of:
e) determining whether an animation function selection signal is inputted after the sculpture was produced;
f) outputting, when the animation function selection signal is inputted, motion data corresponding to each stored image which expresses each different motion; and
g) adding, when a signal for selecting any one of the motion data among the plurality of the motion data is received, the selected motion data to the sculptured image, creating an animated image, and outputting the animated image.

3. An apparatus for producing a character sculpture, the apparatus comprising:
a keyboard through which a user may input an operation signal;
a scanner for scanning a corresponding object and outputting scanned data;
a database for storing a 3-dimensional (3D) image having various body-shapes or garments and an expression image which is capable of being replaced with each part of a body;
a control unit for converting the scanned data inputted from the scanner into 3D data, creating a scanned image, mixing the scanned image with the 3D image and expression image which are read from the database, and creating a sculptured image;
a display for displaying the scanned image or the sculptured image under control of the control unit; and
a 3D sculpturing device for printing, milling or engraving materials under control of the control unit, and producing a character sculpture corresponding to the sculptured image.

4. The apparatus as set forth in claim 3, wherein the control unit comprises at least any one of:
a scanning module for controlling driving of the scanner, converting 2-dimentional (2D) scanned data into 3D data, and creating a scanned image;
an image mixing module for mixing the scanned image with the 3D image and expression image, and creating a sculptured image which is characterized and caricatured; and
an animation module for animationizing the sculptured image mixed through the image mixing module, and endowing predetermined motions to the sculptured image.

5. The apparatus as set forth in claim to 3, further comprising:
an animation outputting unit for outputting the image animated by the animation module of the control unit;
a storage for storing the animation data inputted from the animation outputting unit, on a USB storage or a compact disc (CD) which is loaded therein; and
a terminal outputting unit for outputting the animation data inputted from the animation outputting unit, to a mobile terminal which is connected thereto.
